(19) United States
(12) Patent Application Publication
(10) Pub. No.: US 2006/0239640 A1
(43) Pub. Date: Oct. 26, 2006

(54) Contents information displaying device and method

(76) Inventors: Junichiro Watanabe, Tokyo (JP); Yujin Tsukada, Saitama (JP); Takaaki Ishii, Kawasaki (JP); Isshu Nakajima, Fuchu (JP); Yukinobu Maruyama, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/341,656

(22) Filed: Jan. 30, 2006

(30) Foreign Application Priority Data
Apr. 11, 2005 (JP) 2005-113007

(51) Int. Cl. H04N 5/91

(52) U.S. Cl. 386/83

(57) ABSTRACT

There are growing needs to efficiently programs desired to be viewed from among contents spreading to a channel direction and a time axis direction. However, GUI having a hierarchical structure and requiring numerous button operations require users to perform several complicated operations to view desired image contents. The present invention displays plural programs on one screen to make it easy for users to find programs desired to be viewed from among plural programs. The present invention has a means for controlling time information of reproduced images, and displays recorded images when a control time is older than a current time, program information guide (EPG) when the control time is later than the current time, and programs being broadcast when the control time is the current time.

### CLAIM OF PRIORITY

The present application claims priority from Japanese application JP 2005-113007 filed on Apr. 11, 2005, the content of which is hereby incorporated by reference into this application.

### FIELD OF THE INVENTION

The present invention relates to a display device for displaying TV and other image contents.

### BACKGROUND OF THE INVENTION

Recently, television's broadcasting styles have diversified and the number of programs that users can view has increased. The television's broadcasting styles include terrestrial digital broadcasting in the process of shift from terrestrial analog broadcasting, BS (Broadcast Satellite) broadcasting and CS (Commercial Satellite) that use communications satellites, and cable-broadcasting cable television (CATV). Broadcasting service exists that provides channels more than 100. It is becoming general for users to use an electronic program guide (hereinafter referred to as EPG) to select programs desired to be viewed without fail from such numerous channels. By using EPG information, the users have only to select programs desired to be viewed from a list of programs classified by colors for each of genres by moving a cursor of GUI to make a reservation for the recording of the programs, or can search for a program desired to be viewed by inputting keyword of a genre or a program name.

On the other hand, as means for recording TV programs, DVD recorders with HDD mounted are coming into wider use. As the capacity of HDD increases, the amount of data that can be recorded and stored has increased to such an extent that one week to one month worth of TV programs can be recorded. The number of TV sets equipped with plural tuners is increasing. Accordingly, a situation is becoming realistic in which plural TV programs are recorded all the time. As a result, the users, can access contents desired to be viewed from among numerous contents spreading to a time axis direction and a channel direction, such as information about previously recorded programs, programs being currently broadcast, and future programs.

### SUMMARY OF THE INVENTION

However, existing TV interfaces make it difficult for anyone to easily access such an enormous amount of contents, bringing about the present situation in which the users are forced to operate a remote control many times and GUI having a hierarchical directory structure.

The users must search for contents desired to be viewed from among numerous contents such as information about previously recorded data, programs being currently broadcast, and future programs that spread across a virtual space formed from a time axis and a channel axis. However, it is impossible to efficiently perform searching (zapping) for plural programs among channels and zapping in a time axis direction at the same time.

An object of the present invention is to solve the above-described problems and provide an interface for efficiently finding and viewing programs desired to be viewed from among not only images currently on air over plural channels but also contents including previously recorded images and EPG information of future programs.

To achieve the above-described object, the present invention is a contents information displaying device that includes: plural information receiving units; a recording unit that records received contents; a display unit that displays the contents; an input unit that inputs operation signals; and a control unit that controls these units in a generalized manner, wherein the control unit splits a screen into plural subscreens in the display unit and displays the contents on the subscreens.

The present invention displays plural programs on one screen at the same time to make it easy to find programs desired to be viewed from among the plural programs.

The present invention has a means for controlling time information of reproduced images. It displays recorded image data (corresponding voice data if required) and EPG when a set time is older than a current time, displays EPG information when a set time is later than the current time, and displays programs being broadcast when a set time is equal to the current time.

To explicitly inform the user of the time information, the present invention displays a clock on one of the subscreens, and sets a display time of the clock to a user-set time, thereby informing the user of the set time.

Since plural contents are displayed on the screen at the same time by the present invention, plural contents can be viewed without switching the channels. Since the time axis can be easily moved, previously recorded image data and EPG information, programs being currently broadcast, and future EPG can be easily accessed. Specifically, by the present invention, contents searching (zapping) among numerous channels and zapping in the time axis direction can be performed easily and efficiently. Since operations on a traveling system of the remote control are reflected at the time in plural contents being displayed, plural contents can be handled at the same time.

### BRIEF DESCRIPTION OF THE DRAWINGS

FIG. 1 is an explanatory drawing showing an outline of a system of the present invention;

FIG. 2 is an explanatory drawing showing the concept of a virtual contents space of the present invention;

FIG. 3 is an explanatory drawing showing the conceptual diagram of an internal structure of a memory unit of the present invention;

FIG. 4 is an explanatory drawing showing an example of a main screen of the present invention;

FIG. 5 is an explanatory drawing showing the concept of a virtual contents space of the present invention when cut at a given time;

FIG. 6 is an explanatory drawing showing the concept of images displayed at a given time;

FIG. 7 is an explanatory drawing showing an example when a set time and the time of contents to be displayed are equal;

FIG. 8 is an explanatory drawing showing the concept of a virtual contents space of the present invention when cut at different times for different tuners;

FIG. 9 is an explanatory drawing showing the concept of displayed contents at different times for different tuners;

FIG. 10 is an explanatory drawing showing a display example when a set time is set to a past time;

FIG. 11 is an explanatory drawing showing a display example when a set time is set to a future time;

FIGS. 12A, 12B, 12C, 12D, and 12E are explanatory drawings showing different display examples for different set times;

FIG. 13 is an explanatory drawing showing a remote control of the present invention;

FIG. 14 is an explanatory drawing showing an example of selecting a time by using a remote control of the present invention;

FIG. 15 is explanatory drawing showing a flow of searching for a past program;

FIG. 16 is explanatory drawing showing a flow of searching for a future program;

FIG. 17 is explanatory drawing showing an example of moving a cursor by using a remote control of the present invention;

FIG. 18 is an explanatory drawing showing an example of switching to a full screen display by using a remote control of the present invention;

FIG. 19 is an explanatory drawing showing a flow of a program search method of the present invention;

FIG. 20 is an explanatory drawing showing an example of returning a current time to a set time by using a remote control of the present invention;

FIGS. 21A, 21B, 21C, and 21D are explanatory drawings showing display examples of a category view;

FIG. 22 is an explanatory drawing showing an example of a method of selecting a date;

FIG. 23 is an explanatory drawing showing an example of a method of selecting a date;

FIG. 24 is an explanatory drawing showing a display example of a category view;

FIG. 25 is an explanatory drawing showing an example of a method of category selection;

FIG. 26 is an explanatory drawing showing an example of a method of keyword search; and

FIG. 27 is an explanatory drawing showing an example of displaying identical contents on plural screens.

### DETAILED DESCRIPTION OF THE PREFERRED EMBODIMENTS

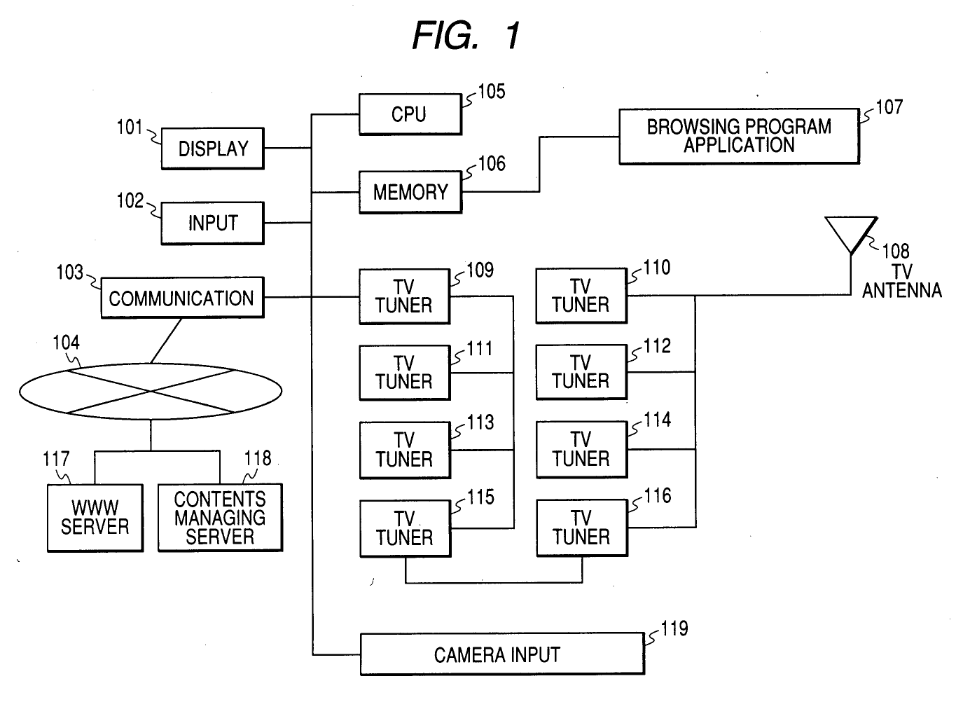

Hereinafter, embodiments of the present invention will be described with reference to the accompanying drawings. FIG. 1 is a schematic block diagram showing one embodiment of the present invention. The reference numeral 101 designates a display unit for displaying contents; 102, an input unit for inputting operation signals; 103, a communication unit for acquiring EPG information and image contents via an Internet network; 104, an Internet network; 105, an operation unit; 106, a memory unit for recording recorded contents; 107, an information browsing program that searches for contents stored in the memory unit and displays them in the display unit; and 108, a TV antenna.

The information displaying device of the present invention receives plural program contents through plural TV tuners. In FIG. 1, eight TV tuners 109, 110, 111, 112, 113, 114, 115, and 116 are connected to a TV antenna so that eight channels can be received at the same time. However, the number of TV tuners may be greater or less than eight so long as there are plural TV tuners.

The present invention basically comprises: the TV tuners 109 to 116 for receiving TV images; the memory unit 106 for storing received images and EPG; the operation unit 105 for searching image data stored in the memory unit for data corresponding to a set time; and a browsing program for browsing searched image data and EPG.

In this basic configuration, an EPG can be acquired from the antenna by using the TV tuners, while an EPG distributed from the WWW server 117 can be acquired through the Internet network 104 by using the communication unit 103.

The basic configuration may be built into an existing device including a display (display unit 101) such as a television and a PC (personal computer) to display image data and an EPG on the display. Alternatively, the display unit 101 may be externally provided.

The present invention may be connected not to the TV tuners but to a camera system such as a surveillance camera that is performing photographing all the time, to receive contents acquired from the camera information reading unit 119. As the EPG, data appended as metadata added to digital broadcasting may be acquired via the TV tuners, or data broadcast using gap bands of radio waves of analog broadcasting may be acquired. Alternatively, the Web server 117 that provides EPG information may be accessed using the Internet via the communication unit to acquire the EPG. Still, alternatively, instead of TV programs and surveillance camera images, streaming data of image contents may be received from a contents managing server 118 that distributes image contents.

The information browsing program 107 is stored in the memory unit 106. When the operation unit 105 activates the information browsing program 107, image data of TV programs and EPG information that have been acquired via the TV tuners, contents stored in the memory unit, camera images inputted from the camera information reading unit, information delivered from the Web server 117 and the contents managing server 118 that has been acquired from the communication unit via the Internet are displayed on the screen.

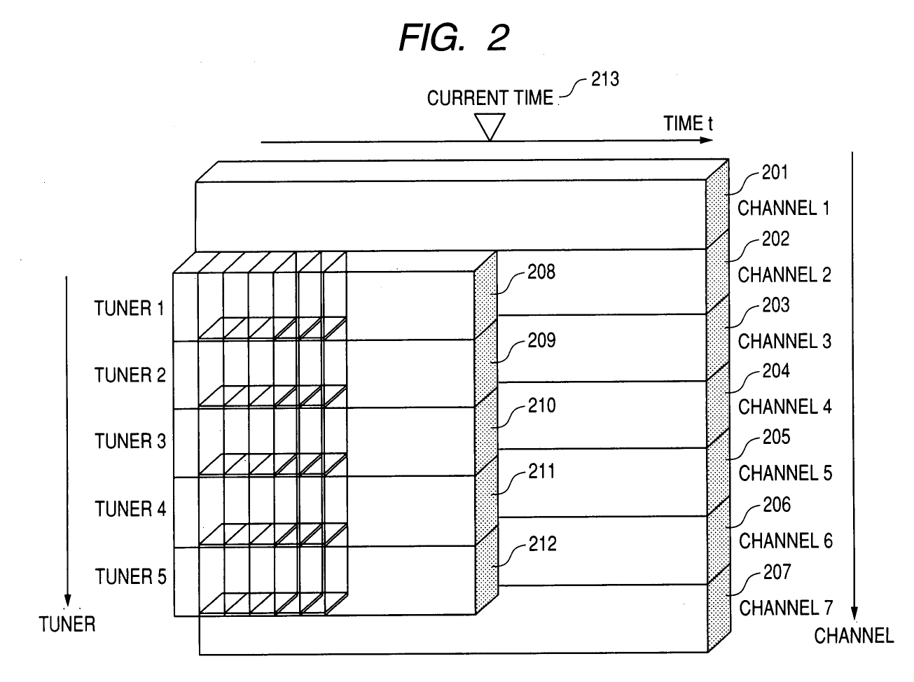

FIG. 2 schematically shows a virtual space on which contents exist when recorded image and voice contents of TV programs and EPG information are processed by the present invention. In the drawing, the horizontal axis is a time axis and the vertical axis is a channel axis or tuner axis.

In the drawing, the contents space comprises two groups—a group including seven blocks 201, 202, 203, 204, 205, 206, and 207 that are representative of channels, and a group including five blocks 208, 209, 210, 211, and 212 that are representative of tuners. Although, in this drawing, five blocks are shown to represent the number of tuners and seven blocks are shown to represent the number of channel, the numbers may be arbitrary. However, usually, the number of channels is greater than the number of tuners.

A block representative of a tuner can be placed in the same position as any one of blocks representative of channels, meaning that TV programs of several channels specified in the tuners from among numerous channels can be recorded in the memory unit.

Therefore, in the drawing, blocks representative of tuners are consecutively placed in the direction of tuner number, but need not necessarily be placed in same positions as consecutive channels, such as channels 1, 3, and 4.

A block representative of a tuner comprises still images produced by splitting recorded image data by frames. In the drawing, each of several planes placed inside a block represents a still image.

The channel blocks comprise EPG and stretch across a current time 213. On the other hand, the tuner blocks, which comprise image data recorded in the memory unit, exist up to a current time but do not exist in future times. By setting the tuner blocks with correspondences with any positions in the channel axis, a user selects programs desired to be viewed from among numerous channels.

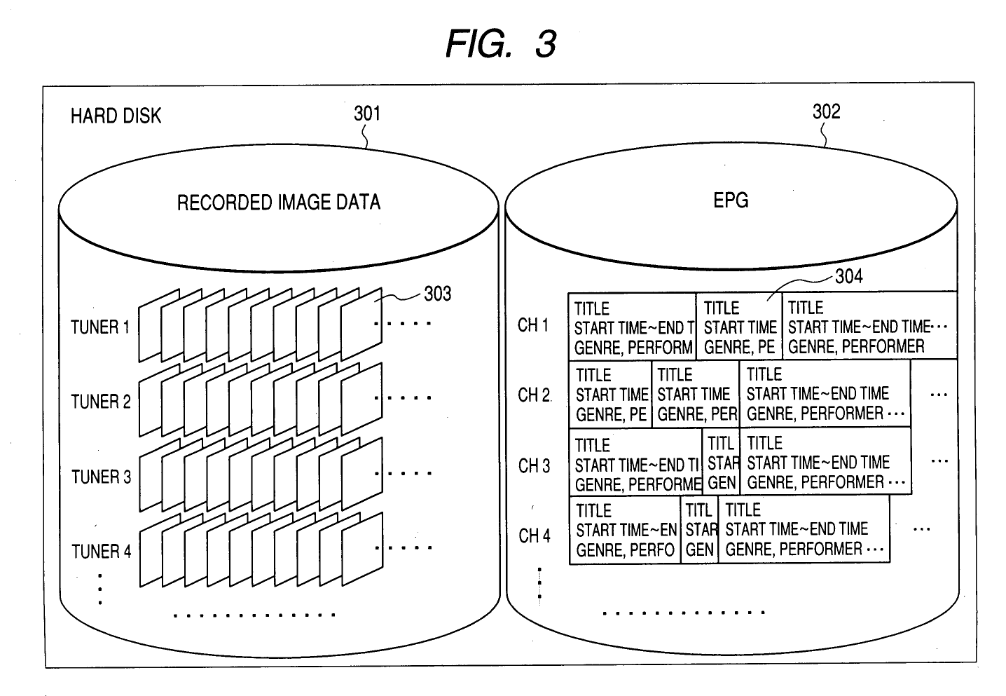

FIG. 3 is a drawing showing a basic configuration of the memory unit. To achieve an interface of the present invention, image contents are split by frames 303, and added with time information and information indicating a channel associated with the image contents before being stored in an area 301 in the memory unit. The frame is the smallest unit in which moving image data is split into still images. In Japan, for example, one still image or a frame is generated every 1/30 seconds.

EPG information 304 is stored in another area 302 in the memory unit. EPG, which is summary information of individual programs, contains titles of the programs, start time and end time of the programs, genres of programs, actors' names, and the like. In addition to the above-described information, the EPG may various information such as still images and short moving images. In this embodiment, with programs that are broadcast (were broadcast or are scheduled to be broadcast) at a specific time in a specific broadcast channel, images and voices stored in the storage area 301 after having being already broadcast, images and voices being currently received over a tuner, and past, present, and future EPG information are referred to collectively as program contents.

The information browsing program accesses these contents such as image data and EPG stored in the memory unit to display them in the display unit. For example, when a set time is a past time, it successively reads out frames after the set time from among recorded image data and displays them, and at the same time accesses past EPGs to display recorded moving images and EPG of the program or selectively display either of them. When a set time is a current time, the information browsing program immediately displays recorded image data, or displays broadcasted images of a tuner-received program being currently broadcast without editing. When a set time is a future time, the information browsing program accesses only EPG information to display character information and other information of the EPG information.

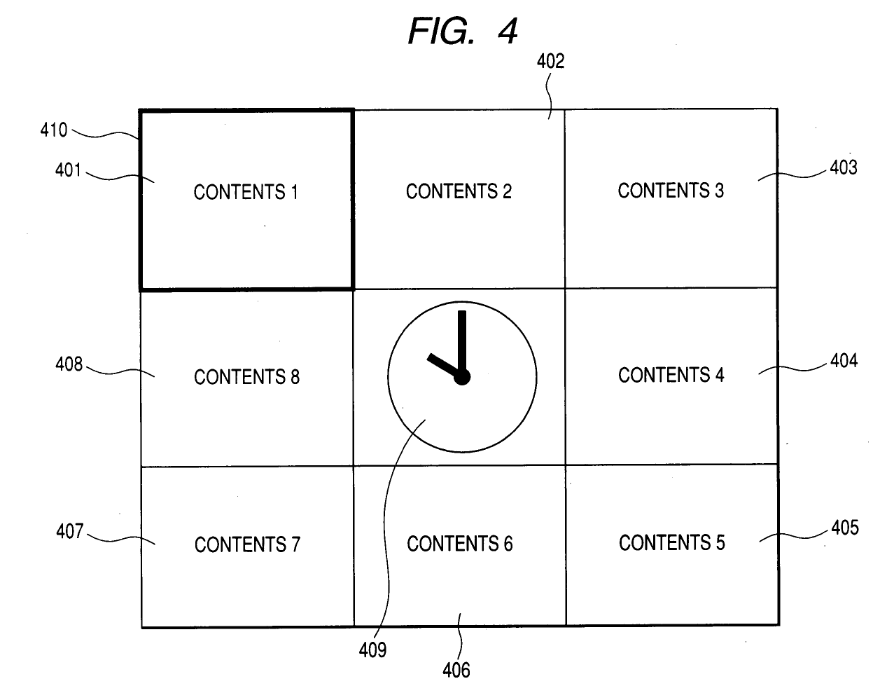

FIG. 4 shows a screen example of the present invention. The screen is split into three portions in the vertical direction and the horizontal direction, respectively, and is split into a total of nine subscreens 401, 402, 403, 404, 405, 406, 407, 408, and 409. A clock is displayed on a central subscreen 409, and displays a current time in an initial state. In FIG. 3, on eight subscreens except the clock, broadcast images of eight programs received over eight tuners are displayed.

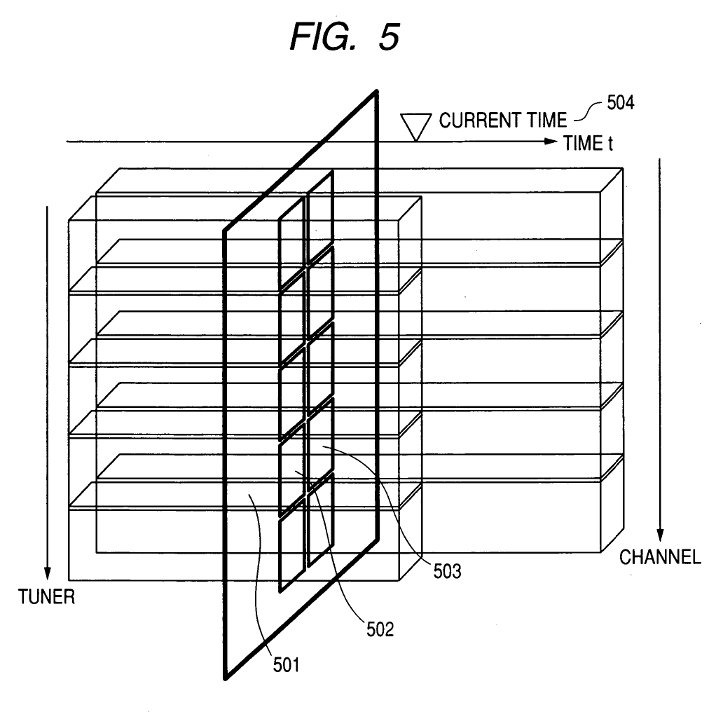

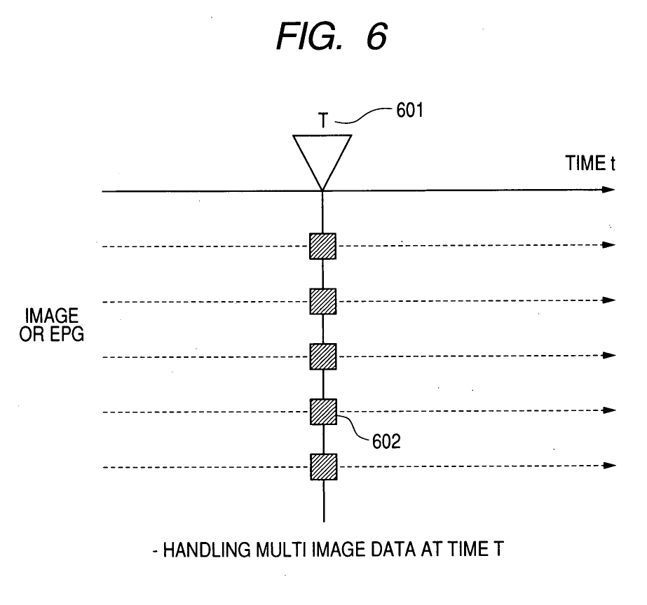

FIG. 5 shows the case where the number of channels is equal to the number of tuners in the contents virtual space shown in FIG. 2. The screen of FIG. 4 shows a cross section 501 of a tuner block, a cross section 503 of a channel block, or both of them displayed on the eight subscreens when the virtual contents space is cut out by a plane 501 vertical to the time axis at a given point of the time axis as shown in FIG. 5. As a result, as shown in FIG. 6, an image 602 of each image stream at a point T601 on the time axis is displayed on each subscreen.

The blocks representative of the tuners comprise recorded image data, and exist in only time zones older than the current time 504. The blocks representative of the channels comprise EPGs, and exist throughout all time zones.

In FIG. 5, if a set time is set to be older than the current time 504, recorded image data, EPG of a recorded program, or both of them is displayed on the subscreens of FIG. 4. In FIG. 5, when a set time is a current time, a program being broadcast is displayed on a subscreen of FIG. 4. In FIG. 5, when a set time is later than a current time, EPG is displayed on a subscreen of FIG. 4.

In FIG. 4, a cursor 410 is displayed on one of the subscreens, and can be moved using a remote control described later so that it is displayed on any one of the nine subscreens. In the drawing, only for a TV program displayed highlightedly on a subscreen by the cursor, voice is reproduced.

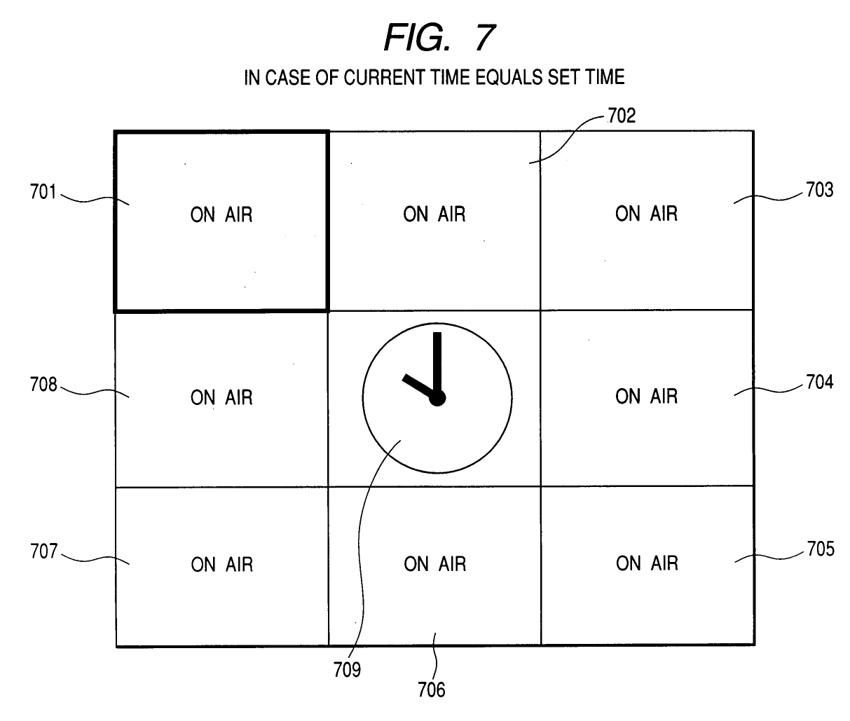

A method of displaying cross sections of the virtual space as shown in FIG. 5 or 6 applies when set times match among all channels. An example is the case where a set time of the clock matches a current time as shown in FIG. 7, and programs of all subscreens are currently being broadcast.

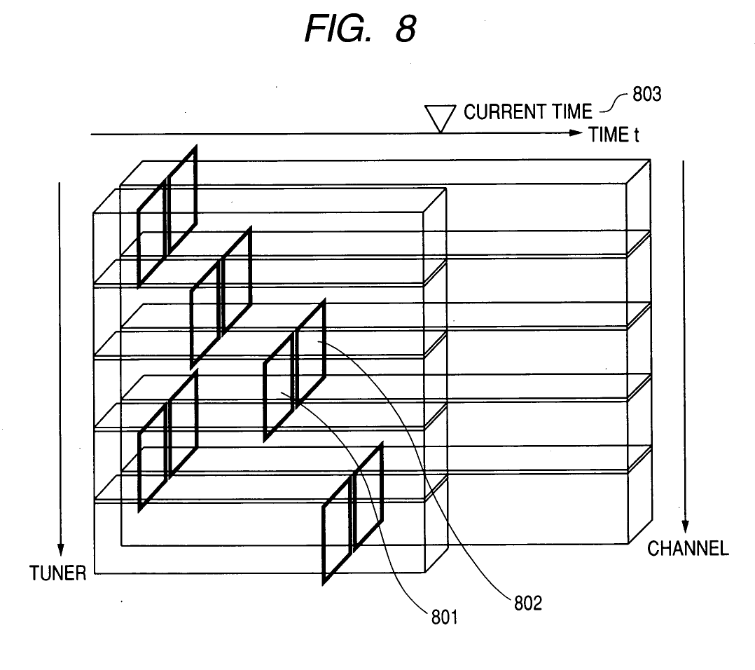

FIG. 8 shows the same virtual contents space as shown in FIG. 5. In this case, all image streams are not cut at an identical time but cut (801) at different points for different channels.

In FIG. 8, when a time in a cut surface of each tuner or channel is set to be older than a current time 803, recorded image data, EPG of a recorded program, or both of them is displayed on a subscreen of a corresponding channel of FIG. 4. In FIG. 8, when a time in a cut surface of each tuner or channel is a current time, a program being broadcast is displayed on a subscreen of a corresponding channel of FIG. 4. In FIG. 8, when a time in a cut surface of each tuner or channel is later than a current time, EPG is displayed on a subscreen of a corresponding channel of FIG. 4.

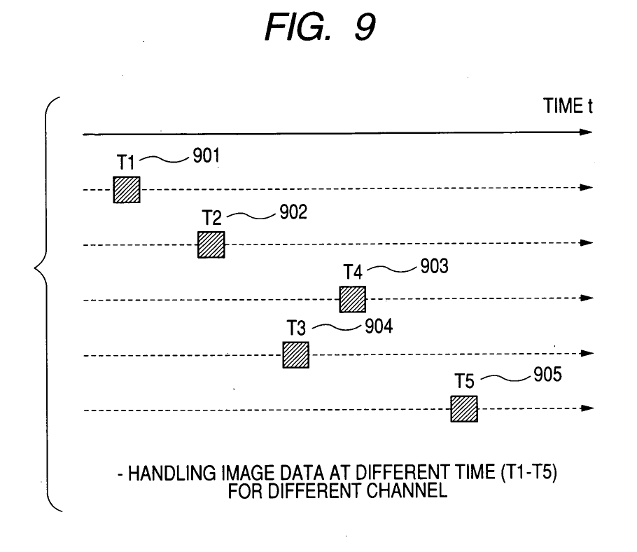

FIG. 9 shows the state of FIG. 8 viewed from the horizontal direction with respect to the time axis. It displays images at different times for different channels. In this example, images are cut at times 901, 902, 903, 904, and 905 for five channels.

The cutting of the virtual space as shown in FIG. 8 or 9 is performed when not all times of the subscreens match. For example, when a set time is set to be later, since several programs have been already broadcast at a current time, EPG at the set time is displayed, while programs being currently broadcast are displayed if they are being broadcast at the set time. In such a case, times do not match among the channels and images at different times for different channels are displayed.

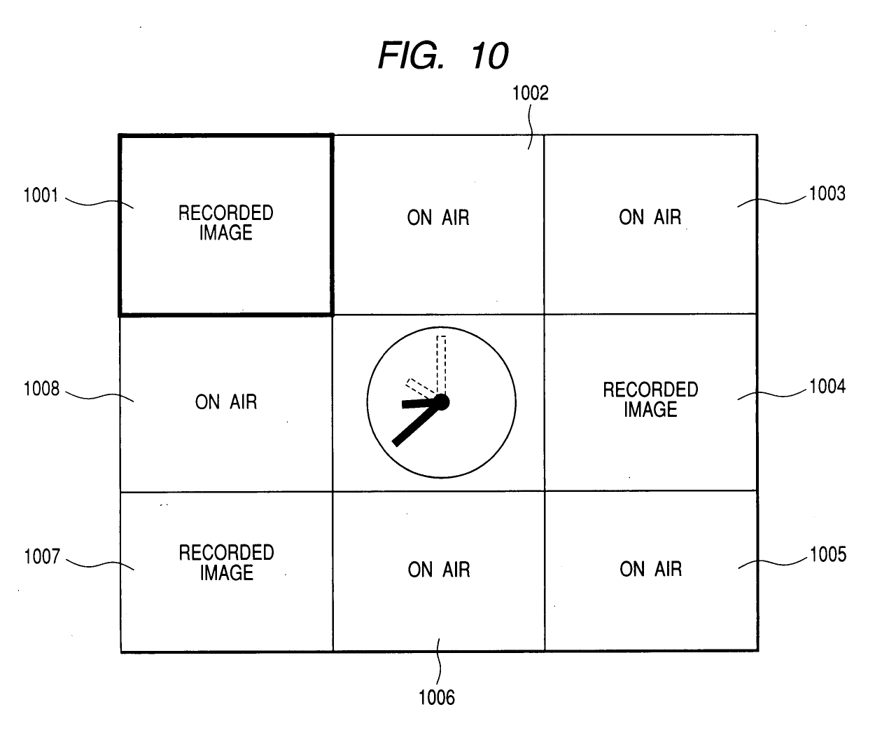

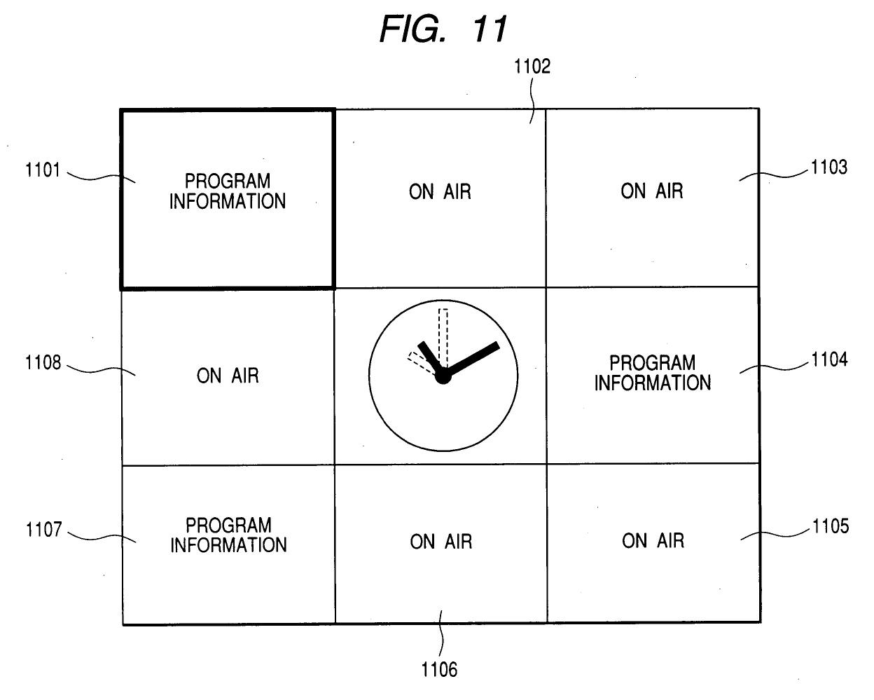

FIGS. 10 and 11 show examples of screens to which such a cutting method is applied, wherein a past time is set in FIG. 10, while a future time is set in FIG. 11. A description will be made of FIG. 10. In the drawing, a current time is 10:00, and a set time is about 8:40, which is older than the current time. In this case, the current time and the set time are displayed at the same time in overlapped form. For example, the current time is displayed as a grey analog clock needle, and the set time is displayed as an analog clock needle of more conspicuous color (e.g., red) so that the current time and the set time can be distinguished from each other. In the drawing, five programs 1002, 1003, 1005, 1006, and 1008 are the same programs as broadcast at 8:40, and are being broadcast at the current time 10:00 as well. Three programs 1001, 1004, and 1007 being broadcast at the current time 10:00 are different from programs broadcast at 8:40. In such a case, there are several methods of displaying subscreens when a set time is set to 8:40.

One method is to display information of an identical time on all screens. In this case, when a same program is broadcast at the past time 8:40 and at the current time 10:00, on a subscreen on which the program is displayed, an image at 8:40 of the program being currently broadcast is displayed. This method corresponds to the case where all programs are cut at an identical time, as shown in FIG. 5.

Another method is to display, when a same program is broadcast at the set time 8:40 and at the current time 10:00, an image at the time of 10:00 of the program being broadcast is displayed even when 8:40 is set. With this method, when a time is set to 8:40, an image at the time of 10:00 is displayed on one subscreen, and an image at the time of 8:40 is displayed on another subscreen. This corresponds to the case of FIG. 8 or 9.

Likewise, a description will be made of FIG. 11. In the drawing, a current time is 10:00, and a set time is about 10:10, which is later than the current time. In this case, the current time and the set time are overlapped and displayed at the same time. For example, the current time is displayed as a grey analog clock needle, and the set time is displayed as an analog clock needle of more conspicuous color (e.g., blue) so that the current time and the set time can be distinguished from each other. In the drawing, five programs 1102, 1103, 1105, 1106, and 1108 will be broadcast at the future time 10:10 as they are currently. Three programs 1101, 1104, and 1107, which are being broadcast at the current time 10:00, will have been broadcast at the future time 8:40.

In such a case, although EPG exists at the set time 10:10, image data does not exist because it is not yet broadcast. Therefore, if a program being currently broadcast will not have ended at the future time 10:10, an image at the current time 10:00 is displayed. On the contrary, if a program being currently broadcast will have ended at the future time 10:10, EPG of a program at the set time is displayed.

As described above, in FIG. 10 or 11, on several subscreen, recorded images at a past times or EPG information at a future time are displayed as program contents corresponding to a set time, while, on other several subscreens, images being broadcast (received) are displayed as program contents at a current time. This corresponds to the case where cut surfaces corresponding to two times in FIG. 8 or 9 exist.

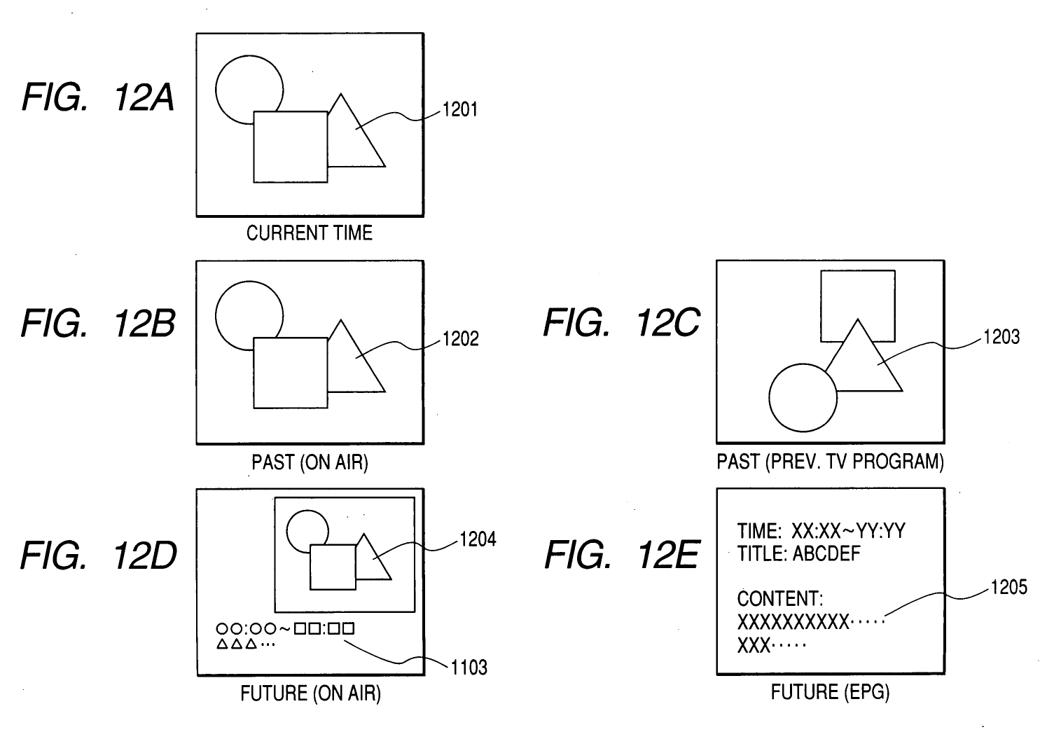

FIG. 12 shows an example of displaying a subscreen at different set times. When a set time is a current time, as shown in FIG. 12A, an image 1201 at the current time of a program being currently broadcast is displayed on the subscreen. When a set time is a past time, the following two cases are possible. One is the case where the set time is later than the start time of a program being currently broadcast. The other is the case where the set time is older than the start time of a program being currently broadcast. In the former case, for example, as shown in FIG. 12B, an image 1202 at a current time of a program being currently broadcast is displayed, or an image reversed up to the set time is displayed. In the latter case, as shown in FIG. 12C, an image at the set time of a past program 1203 is displayed.

Also when a set time is a future time, the following two cases are possible. One is the case where the set time is earlier than the start time of a program being currently broadcast. The other is the case where the set time is later than the end time of a program being currently broadcast. In the former case, for example, an image at a current time of a program being currently broadcast is displayed on a subscreen. EPG information may be displayed on top of another image (1204). In the latter case, EPG information corresponding to the set time may be displayed in text form or the like. The EPG information may be displayed in different colors for different genres, or displayed using icons. Other display methods may also be used.

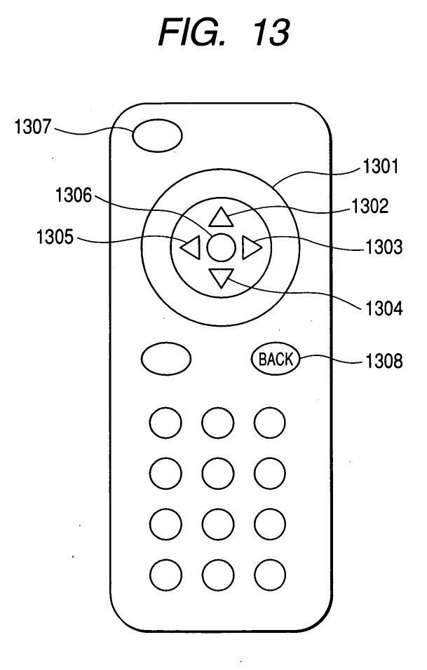

FIG. 13 shows an example of a remote control for operating a screen by using an information displaying method of the present invention. In the drawing, the reference numeral 1301 designates a rotary dial device; 1302, 1303, 1304, and 1305, up/down/left/right direction keys; 1306, a select key; 1307, a power button; and 1308, a reset button. In addition to these keys, buttons such as numeric keys may be provided.

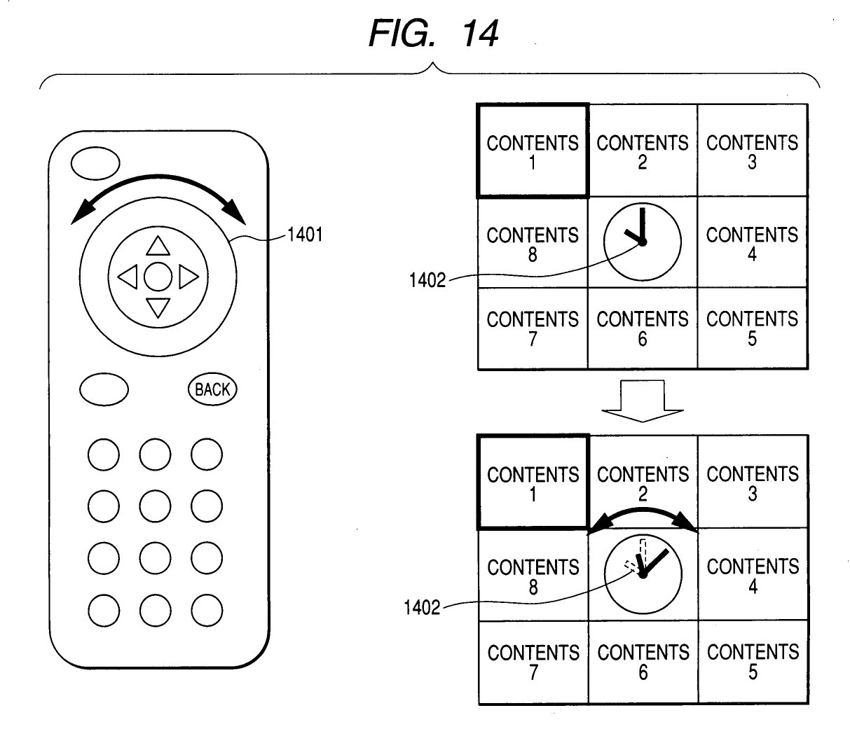

FIG. 14 shows the operation of selecting a time using the remote control shown in FIG. 13. By rotating a dial 1401, needles of a clock 1402 displayed on the screen can be rotated in the direction that rotates the dial. In an example of the drawing, by rotating the dial rightward when a current time is 10:00, a set time is set to about 11:10 (1403).

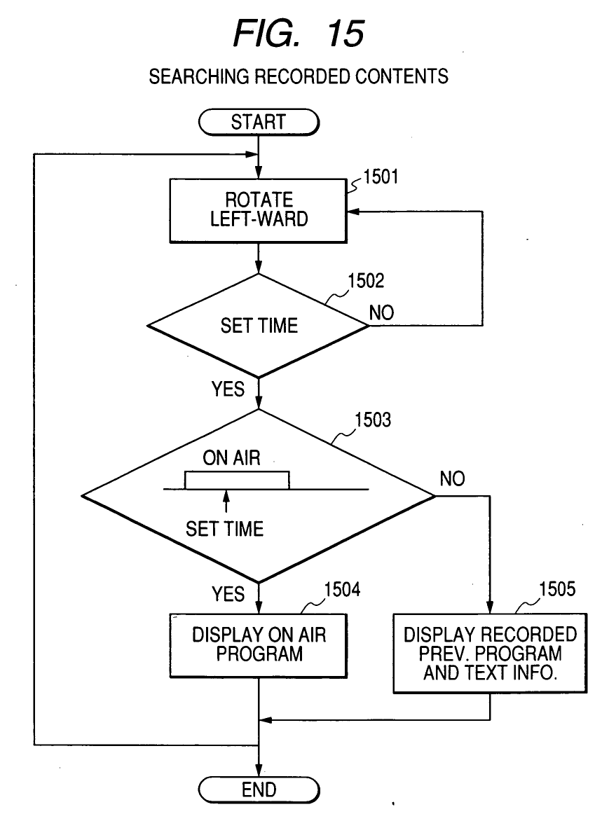

FIG. 15 is a flowchart showing the flow of searching for previously recorded image contents. In the drawing, by rotating the dial of the remote control leftward (1501), a user can set a set time to a time older than a current time. In this case, it will be understood that the needles of the clock are rotated counterclockwise. The set time and the current time are displayed at the same time by overlapping analog clocks of different colors on each other. The user rotates the dial until a desired set time is reached (1502). The information browsing program refers to a user-selected time, time information added to image data stored in the memory unit, program start/end time information of EPG stored in the memory unit, and other information and displays image data and EPG corresponding to the user-selected time.

In the example of the drawing, when the set time is later than the start time of a program being currently broadcast (1503), the information browsing program displays not image data stored in the memory unit but a program being broadcast over a tuner in a subscreen (1504). Or it may retrieve image data at the set time of the program being broadcast from the memory unit to display the image data (reverse display). When the set time is older than the start time of a program being currently broadcast, it retrieves image data of a program at the past set time from the memory unit and displays it along with summary information of the program acquired from EPG stored in the memory unit as required (1504).

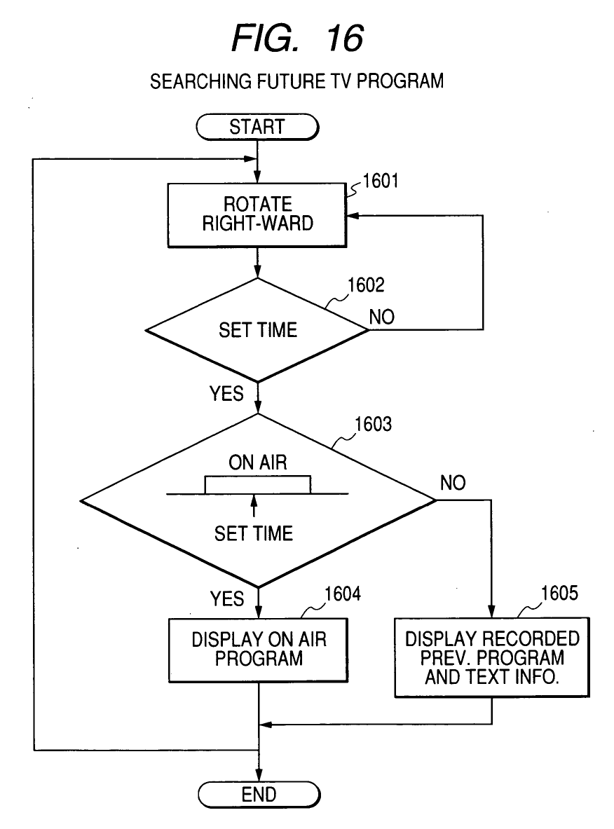

FIG. 16 is a flowchart showing the flow of searching for future programs. In the drawing, by rotating the dial of the remote control rightward (1601), the user can set a set time to a time later than the current time. In this case, it will be understood that the needles of the clock are rotated clockwise. The set time and the current time are displayed at the same time by overlapping analog clocks of different colors on each other. The user rotates the dial until a desired set time is reached (1602). The information browsing program refers to a user-selected time, time information added to image data stored in the memory unit, program start/end time information of EPG stored in the memory unit, and other information and displays image data and EPG corresponding to the user-selected time.

In the example of the drawing, when the set time is earlier than the start time of a program being currently broadcast (1603), an image at a current time of a program being currently broadcast over a tuner is displayed on a subscreen. Or EPG information at the set time retrieved from the memory unit may be displayed in text form. When the set time is later than the end time of a program being currently broadcast, the information browsing program retrieves EPG information of a program of a future time selected from the memory unit and displays the information in text form (1605).

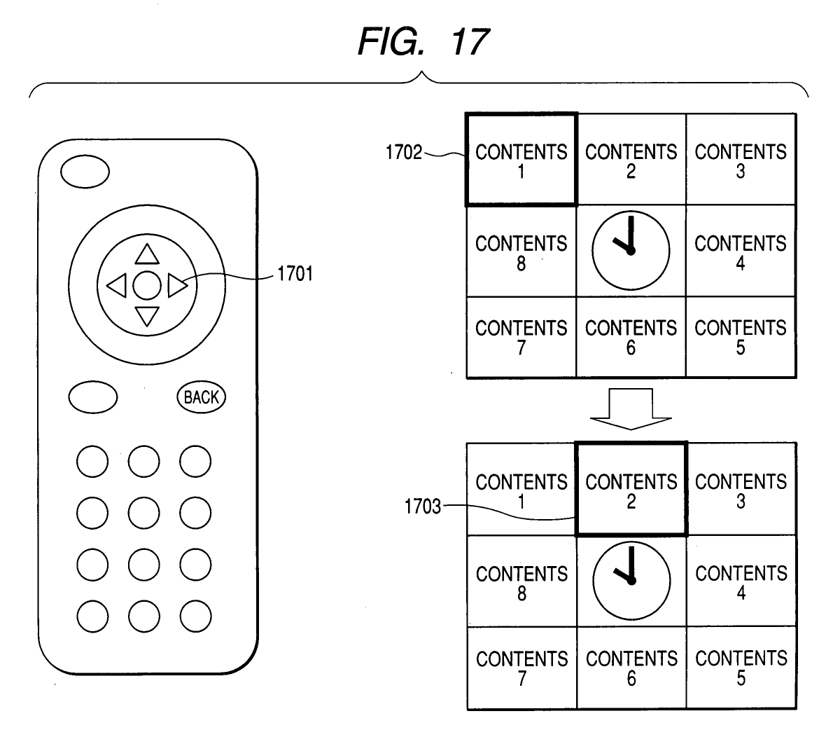

FIG. 17 shows a method of moving the cursor. Pressing direction keys 1701 causes the cursor displayed on the screen to move up, down, left, and right. In the example of the drawing, by pressing the right button 1701 of a direction key, the cursor is moved to the immediately right subscreen (1702, 1703).

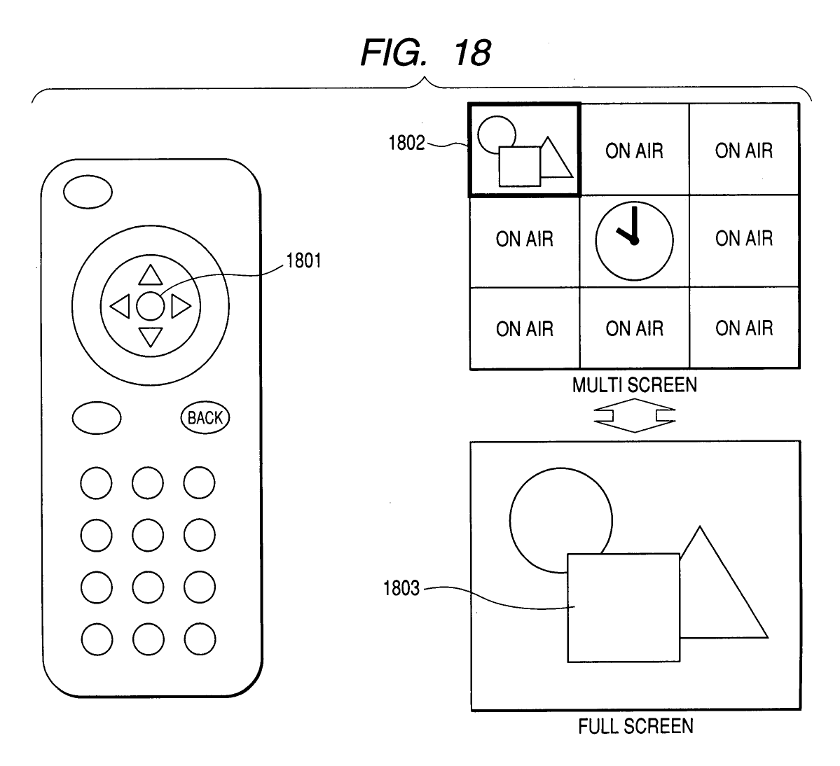

FIG. 18 shows a method of changing a subscreen to a full screen. By pressing a select key 1801, a program of a subscreen whose focus is highlighted can be displayed on a full screen 1803.

By rotating the dial when the full screen is displayed, with the full screen left intact, the set time can be changed to a future or past time. EPG in the case of a future time, and recorded image data and EPG information in the case of a past time are respectively displayed on the full screen. By pressing the up and the down keys when the full screen is displayed, channels can be changed with the full screen left intact.

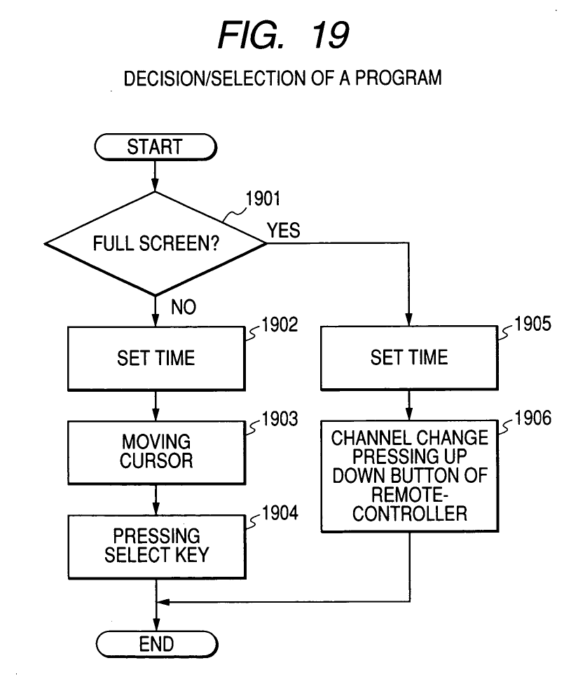

FIG. 19 shows the flow of a series of processes for selecting a program which a user wants to view. The interface of the present invention has two display modes. One is multi-screen mode in which eight programs are displayed on eight subscreens at the same time (1901). The other is full screen mode in which one of eight programs is selectively displayed on a full screen. In any mode, the user can search for a program desired to be viewed by changing channels or set times.

The following describes program searching in the multi-screen mode. In the multi-screen mode, the user rotates the dial of the remote control to perform setting of set times with regard to all eight screens (1902). Specifically, the system retrieves past recorded image data, EPG information, programs being currently broadcast, or EPG information of future programs from the memory unit and displays them.

When the user finds a program desired to be viewed from among the eight programs at a given set time, the user sets the cursor on a subscreen on which the program is displayed by pressing the direction keys of the remote control (1903). By pressing the select key of the remote control in that state, the program can be viewed in the full screen mode (1904).

On the other hand, also in the full screen mode, program searching can be performed. As in the multi-screen mode, by rotating the dial of the remote control, a set time can be set to any time (1905). When the set time is a past time, recorded image data and EPG information are displayed. When the set time is a current time, a program being broadcast is displayed. When the set time is a future time, EPG information is displayed after being retrieved from the memory unit. Also in the full screen mode, channels can be changed by pressing the up and the down buttons of the remote control (1906).

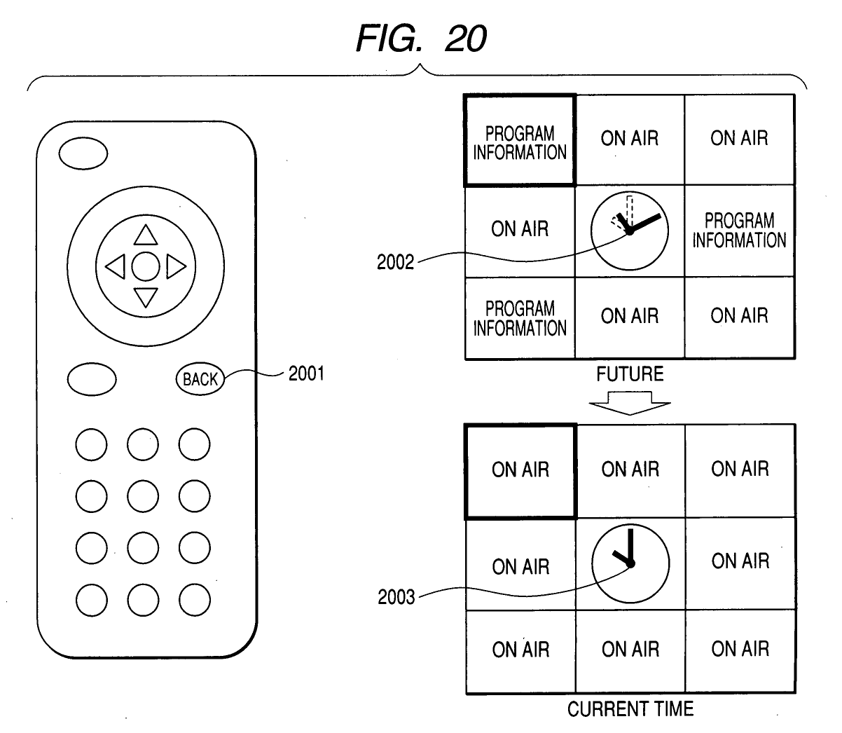

FIG. 20 shows a method for returning to a current time by one click during movement among past and future times by rotating the dial to search for programs. In the drawing, a current time is 10:00 (2002) and a set time is set to a future time 10:10. To return to the current time 10:00 again, by pressing a button 2001 of the remote control, a set time can be set to the current time 10:00 by one click (2002). This operation enables return to the current time without rotating the dial many times even when a set time has been set to a time distant from the current time as a result of rotating the dial to search for programs.

Hereinbefore, a description has been made of the case where TV channels are displayed on the subscreens. EPG information may contain metadata that differs depending on genres. By acquiring the genre information, program searching can be performed with regard to only user's favorite genres. Accordingly, in the interface of the present invention, when a certain genre is specified, only the genre can be displayed on subscreens. Hereinafter, a display method of displaying images of a specified genre on subscreens will be referred to as category view.

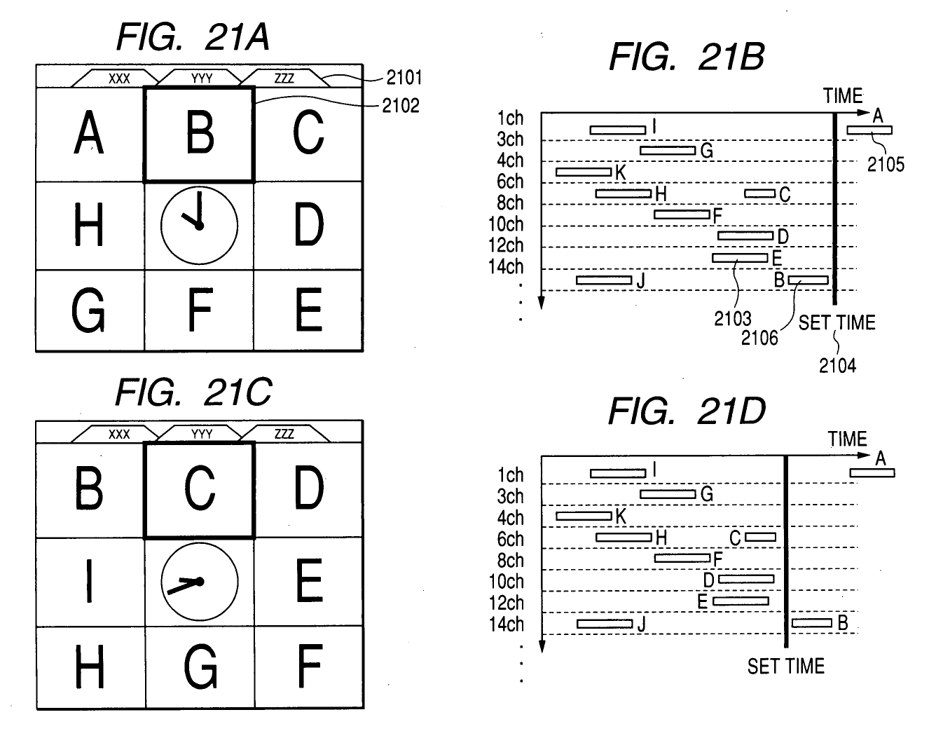

FIG. 21 is a drawing showing an example of category view. Each genre name is displayed as a tab 2101. By selecting a tab of a favorite genre, the user can display programs of the selected genre on the eight subscreens independent of channels.

FIG. 21A shows that category “yyy” is selected at a given set time 10:00 and the cursor is positioned in the center of the upper row.

FIG. 21B shows a time distribution of program contents 2103 corresponding to “yyy” of individual channels. The program contents denote recorded image data, programs being broadcast, EPG, and combinations of them. In this example, 11 program contents from A to K are displayed.

In FIG. 21B, a set time is assumed to be set between start time 2105 of program A and end time 2106 of program B. In such a situation, the interface of the present invention displays program contents of a category “yyy” nearest the set time on a subscreen at a cursor position. In the example of the drawing, program contents B are displayed on a subscreen highlighted by the cursor of FIG. 21A.

In FIG. 21A, programs of a category “yyy” older than the set time are displayed in reverse chronological order, in a rightward (clockwise) direction with respect to a subscreen at a cursor position around the subscreen on which the clock at the center is displayed. In the case of the drawing, programs C, D, E, F, G, and H are displayed in that order. In the drawing, a program of a category “yyy” later than the set time are displayed in reverse chronological order, in a leftward (counterclockwise) direction with respect to the subscreen at the cursor position around the subscreen on which the clock at the center is displayed. In the case of the drawing, program A corresponds to this.

FIG. 21C shows an example of the case in which a set time is set to a time older than the state of FIG. 21A. In this case, as shown in FIG. 21D, it is assumed that programs A and B exist at times later than the set time, and programs C, D, E, F, G, H, I, J, and K exist at times older than the set time.

In this case, as shown in FIG. 21C, programs displayed in the subscreens of the interface of the present invention are displayed in a form that moves them one by one in a leftward spiral direction around the subscreen on which the clock at the center is displayed. Specifically, the future program A is not displayed, the program B is displayed on the subscreen on which the program A has been displayed, the program C is displayed on the subscreen on which the program B has been displayed, and other programs are displayed in the same way.

In the drawing, the time axis is a vertically downward direction or past direction with respect to the paper surface, and the programs are placed in right spiral form toward past times from future times, around the subscreen on which the clock at the center is displayed. Specifically, the programs are placed in the order of A, B, C, . . . , H toward past times from future times.

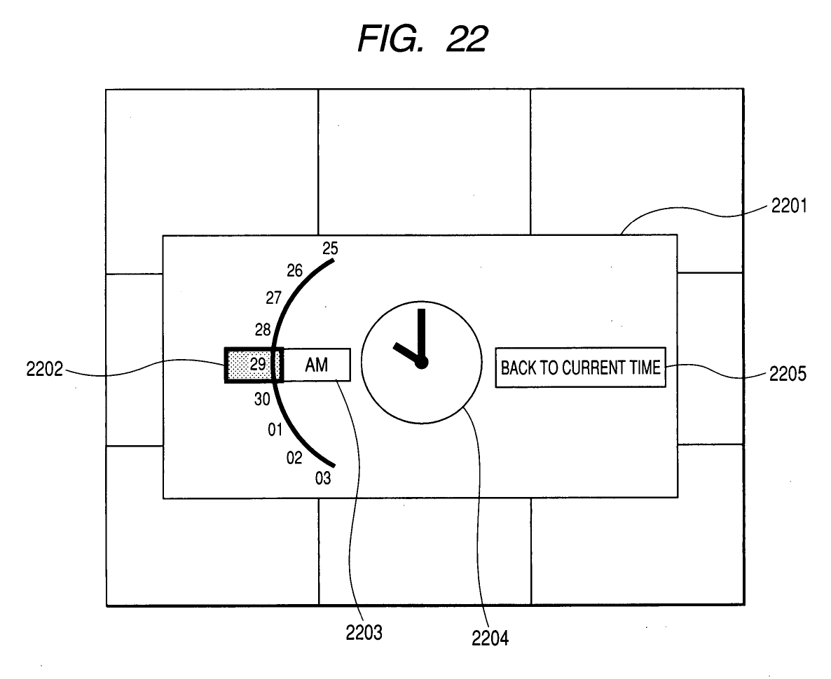

FIG. 22 is a drawing showing a method of setting a search time without rotating the dial. Pressing a proper button of the remote control causes a popup menu 2201 for selecting date to be displayed to enable the user to select operations such as day 2202, selection between morning or afternoon 2203, time selection by the clock 2204, and return to current time 2205. Other items may be selected.

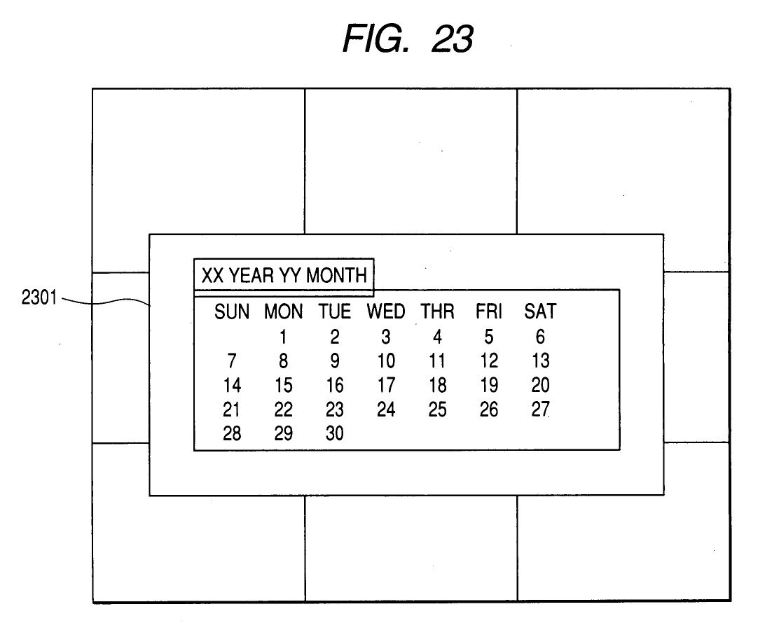

FIG. 23 is a drawing showing another method of setting a search time without rotating the dial. In the drawing, pressing a proper button of the remote control causes a calendar 2301 to be displayed to enable the user to select a desired date by the cursor. By the methods as shown in FIG. 22 or 23, even when a time distance is distant from a current time, image contents can be easily selected.

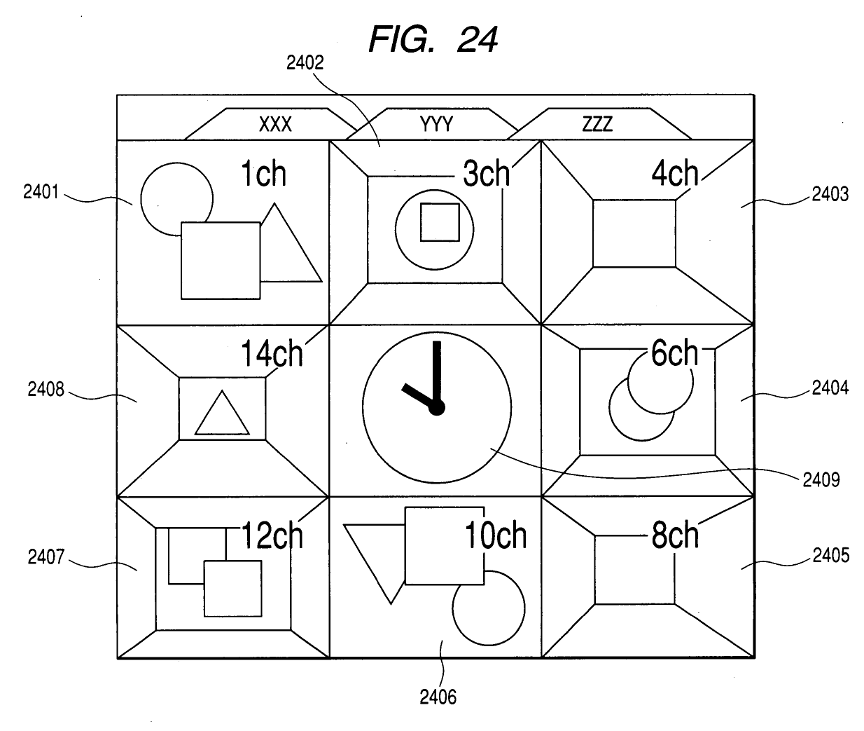

FIG. 24 shows another display method of category view. Programs existing at time distances nearer to a set time are displayed in larger sizes, and programs existing at time distances more distant from a set time are displayed in smaller sizes. Thereby, the user can obtain a sense of searching for programs in a deep space.

In the example of the drawing, programs at times older than a set time 10:00 (2409) are displayed in three types of screen sizes large, medium, and small, which are an order nearer to the set time in the order of shorter time distances to the set time. 2401 and 2406 indicate programs at times nearest 10:00, for example, programs at 9:50 and 9:45. 2403, 2404, and 2407 indicate program at times second nearest 10:00, for example, programs at 8:50, 8:30, and 8:15. 2403, 2405, and 2408 indicate programs at times farthest from 10:00, for examples, programs of 6 hour zone. Although an example of displaying in three levels large, medium, and small is shown in the drawing, displaying in more levels is also possible.

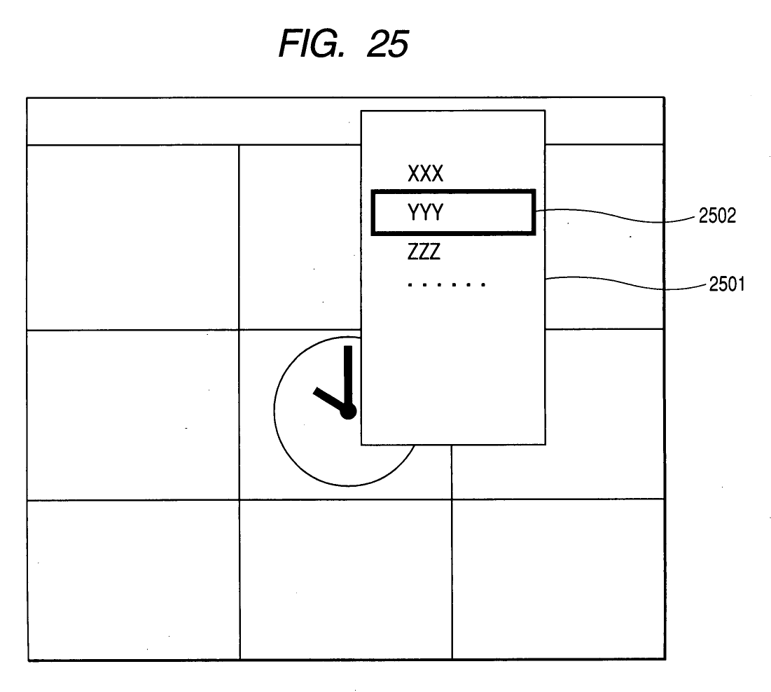

FIG. 25 is a drawing showing a method of selecting categories. Pressing a proper button of the remote control causes a pull-down menu 2501 to be displayed in a proper position of the screen of the interface of the present invention. The user selects a desired genre from the pull-down menu by moving a cursor 2502 to select the genre of programs to be displayed on the subscreens.

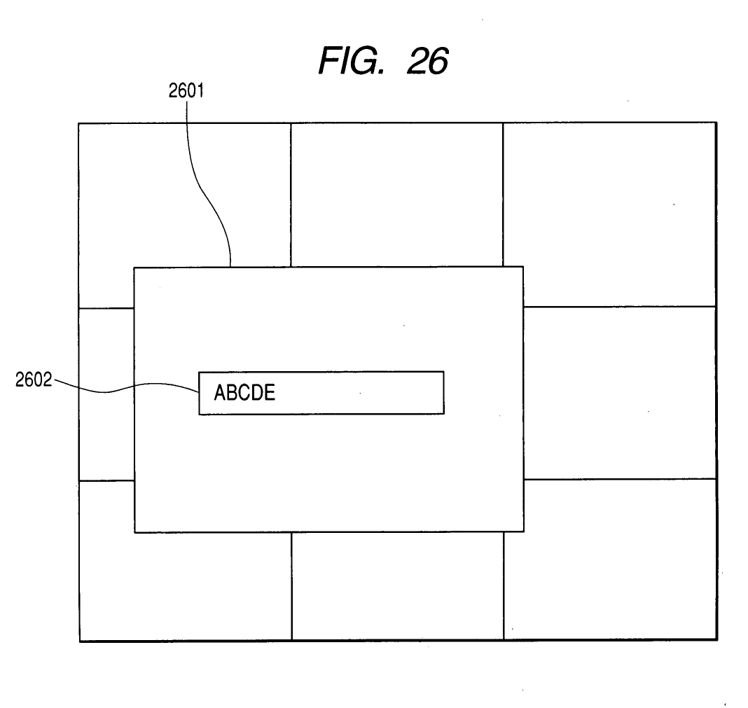

FIG. 26 shows an example of displaying an interface for selecting programs to be displayed on the subscreens by keyword search. By pressing a proper button of the remote control, a popup menu 2601 including a field for inputting keyword as shown in the drawing is displayed. By inputting keyword 2602 by operating buttons such as numeric keys of the remote control, user's favorite programs can be searched for finer than genre selection and displayed on the subscreens of the interface of the present invention.

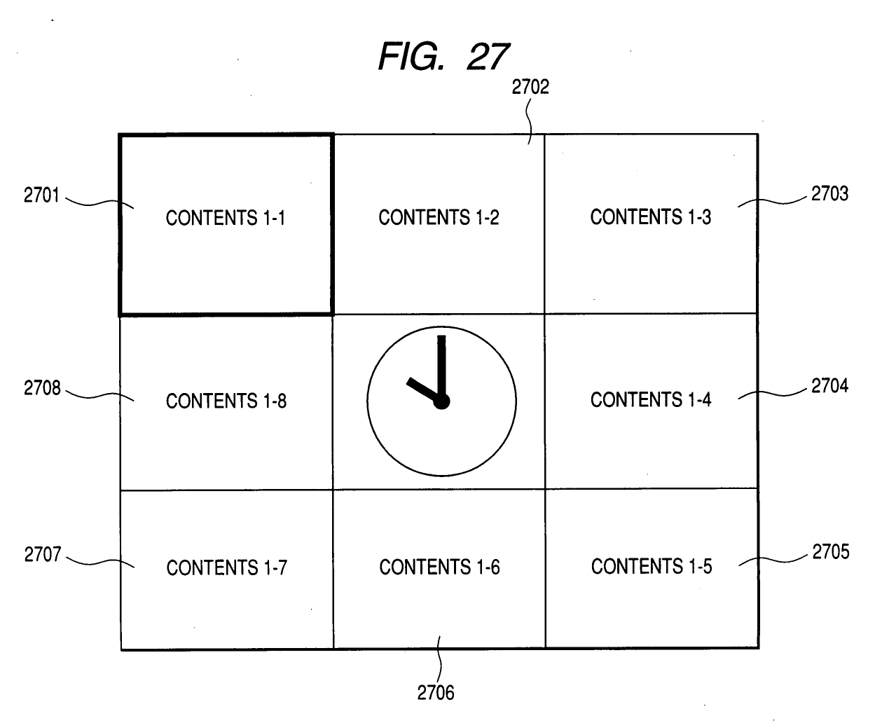

Identical contents split by a fixed time may be displayed. FIG. 27 shows an example of splitting identical contents into eight parts so that the parts are displayed as 2701, 2702, 2703, 2704, 2705, 2706, 2707, and 2708 on the eight subscreens. For example, when contents are a program of 80 minutes, by splitting the contents by 10 minutes and displaying the split contents on the subscreens, the user can view the contents with a resolution of 10 minutes from any time. Since the user can view a scene being currently viewed and a scene broadcast 10 minutes later at the same time, the user can quickly search for exciting scenes in the same contents without having to view the whole contents.

Programs may be classified by broadcasting channels instead of being categorized so that program contents broadcast over an identical channel are displayed on the eight subscreen in a time sequence for each of the programs. The program contents are recorded image data, a program being broadcast, EPG, and the like. For example, program contents at a set time are displayed on a subscreen highlighted by the cursor, and around the subscreen on which the clock at the center is displayed, programs at times earlier than the set time are displayed counterclockwise with respect to the highlighted subscreen, and programs at times later than the set time are displayed clockwise with respect to the highlighted subscreen.

By thus displaying plural program contents of an identical channel on plural subscreens at the same time according to the broadcast times of the programs, channels, that is, broadcasting stations can be used as a search key for program searching. Thereby, after first narrowing down broadcasting stations, the user can search, in a time sequence, for programs desired to be viewed from among programs provided from the selected broadcasting station.

What is claimed is:

1. A program contents output device comprising: plural broadcast information receiving units that are each set to any one of plural broadcasting channels to receive broadcasts of the broadcasting channel; a memory unit that stores images of a program received over the broadcasting channel, and summary information about programs of the plural broadcasting channels as program contents respectively associated with times; an input unit that receives operation input; and a control unit that performs control to output the program contents from the memory unit according to the operation input,
wherein the input unit receives operation input for specifying a set time, and
the control unit compares the set time and a current time,
when the set time is identical with the current time, outputs images of broadcasting channels being received by the plural broadcasting information receiving units,
when the set time is a time older than the current time, retrieves program contents corresponding to the past time from the memory unit to output them, and
when the set time is a time later than the current time, retrieves program contents corresponding to the future time from the memory unit to output them.

2. The program contents output device according to claim 1,
wherein the control unit refers to the summary information when the set time is a past time,
for broadcasting channels that a broadcast program at the past time is identical with a broadcast program at the current time, outputs images of programs received in the broadcast information receiving units at the current time, and
for broadcasting channels that a broadcast program at the past time is not identical with a broadcast program at the current time, reads images received and stored at the past time or the summary information at the past time from the memory unit and outputs them.

3. The program contents output device according to claim 1,
wherein the control unit refers to the summary information when the set time is a future time,
for broadcasting channels that a broadcast program at the future time is identical with a broadcast program at the current time, outputs images of programs received in the broadcast information receiving units at the current time, and
for broadcasting channels that a broadcast program at the future time is not identical with a broadcast program at the current time, reads summary information of the broadcast program at the future time from the memory unit and outputs it.

4. The program contents output device according to claim 1,
wherein the control unit performs output so that an image indicating the set time and the current time, and program contents corresponding to the set time of the broadcasting channels are displayed in combination.

5. The program contents output device according to claim 1, further comprising a display device that displays program contents outputted from the control unit,
wherein, when the input unit receives an input that specifies the set time for which plural broadcasting channels or plural broadcast information receiving units are selected, the display device displays program contents corresponding to the set time of the plural broadcasting channels or the plural broadcast information receiving units as subscreens, respectively.

6. An information browsing program for controlling program contents to be outputted, in a program contents output device comprising: plural broadcast information receiving units that are each set to any one of plural broadcasting channels to receive broadcasts of the broadcasting channel; a memory unit that stores images received over the broadcasting channel, and summary information about programs of the plural broadcasting channels as program contents respectively associated with times; an input unit that receives operation input; and an output unit that outputs the program information,
wherein the information browsing program executes:
a first step of receiving a set time in the input unit;
a second step of comparing the set time and a current time; and
a third step of outputting program contents corresponding to the set time from the output unit,
in the third step, when the set time is identical with the current time, outputs images of broadcasting channels being received by the plural broadcasting information receiving units,
when the set time is a time older than the current time, retrieves program contents corresponding to the past time from the memory unit to output them, and
when the set time is a time later than the current time, retrieves program contents corresponding to the future time from the memory unit to output them.

7. The information browsing program according to claim 6,
in the third step, referring to the summary information when the set time is a past time,
for broadcasting channels that a broadcast program at the past time is identical with a broadcast program at the current time, outputting images of programs received in the broadcast information receiving units at the current time, and
for broadcasting channels that a broadcast program at the past time is not identical with a broadcast program at the current time, reading contents received and stored at the past time or the summary information at the past time from the memory unit and outputting them.

8. The information browsing program according to claim 6,
in the third step, referring to the summary information when the set time is a future time,
for broadcasting channels that a broadcast program at the future time is identical with a broadcast program at the current time, outputting contents of programs received in the broadcast information receiving units at the current time, and
for broadcasting channels that a broadcast program at the future time is not identical with a broadcast program at the current time, reading summary information of the broadcast program at the future time from the memory unit and outputting it.

9. The information browsing program according to claim 6,
in the third step, performing output so that an image indicating the set time and the current time, and program contents corresponding to the set time of the broadcasting channels are displayed in combination.

10. The information browsing program according to claim 6,
in the first step, receiving an input that selects plural broadcasting channels or plural broadcast information receiving units together with the set time, and
in the third step, displaying program contents corresponding to the set time of the plural broadcasting channels or the plural broadcast information receiving units as subscreens, respectively.

11. A program contents output device comprising: a memory unit that stores program contents including images of plural programs, and summary information containing time information corresponding to the programs; and an input unit that receives operation input; and a control unit that performs control to output program contents corresponding to the operation input from the memory unit,
wherein the input unit accepts operation input that specifies at least a set time, and
the control unit searches for time information of program contents stored in the memory unit based on the set time, selects a predetermined number of programs having time information near the set time, and performs output so that program contents of the predetermined number of programs are displayed together on subscreens of a display device.

12. The program contents output device according to claim 11,
wherein the control unit outputs program contents of the predetermined number of programs so that they are placed and displayed on screens of the display device clockwise in a chronological order of the time information.

13. The program contents output device according to claim 12,
wherein the control unit outputs an image indicating the set time along with program contents of the predetermined number of programs so that the image is displayed on a subscreen at a substantially central position of the display device.

14. The program contents output device according to claim 11,
wherein the input unit receives input for changing a set time, and the control unit, when selecting the predetermined number of programs using the changed new set time causes a change of selection result, according to the changed selection result, if programs having been displayed till then are contained in the new selection result, outputs the program contents of the programs so that their display positions are changed; if programs having been displayed till then are not contained in the new selection result, hides the program contents of the programs, and decides the positions in which program contents of programs newly contained in the selection result are displayed, based on a time information order so that clockwise display positions in a chronological order of the time information are maintained.

15. The program contents output device according to claim 11,
wherein the summary information contains category information of the programs, the input unit receives operation input for specifying a category of programs, and the control unit searches for summary information of program contents stored in the memory unit based on the specified category and the set time, and selects the predetermined number of programs.

16. The program contents output device according to claim 11,
wherein the summary information also contains summary information about programs that can be stored in the memory unit in future.
